(19) United States
(12) Patent Application Publication
(10) Pub. No.: US 2016/0138267 A1
(43) Pub. Date: May 19, 2016

(54) POLYURETHANE FOAM BUILDING MEMBERS FOR RESIDENTIAL AND/OR COMMERCIAL BUILDINGS

(71) Applicant: Richard Ettinger, New Canaan, CT (US)

(72) Inventor: Richard Ettinger, New Canaan, CT (US)

(21) Appl. No.: 14/946,402

(22) Filed: Nov. 19, 2015

Related U.S. Application Data
(60) Provisional application No. 62/082,106, filed on Nov. 19, 2014.

(51) Int. Cl. E04C 3/36; C08J 9/00; C08G 18/32

(52) U.S. Cl. CPC E04C 3/36; C08G 18/3221; C08G 18/3206; C08J 9/00

(57) ABSTRACT

Exemplary embodiments generally provide for polyurethane foam studs, beams, and/or sheathing to replace traditional oriented strand board, plywood, wood, steel, and/or concrete in any building structure whether residential, commercial, or industrial. Exemplary embodiments of the polyurethane foam studs, beams, and/or sheathing can be sufficient strength for supporting a structural load, while at the same time improving the thermal efficiency of buildings to reduce and/or eliminate thermal bridging.

### CROSS REFERENCE TO RELATED APPLICATIONS

The present application claims priority to U.S. Provisional Application No. 62.082,106 filed on Nov. 19, 2014, the entirety of which is incorporated by reference herein.

### BACKGROUND

Conventional framing materials, such as wood, steel, and concrete can be used to provide a strong structural frame of a building. While these materials have several desirable properties for use in building construction, they are often inefficient for thermal insulation of a building. For example, a typically exterior wall may be constructed from wood studs with sheathing, such as plywood or oriented strand board secured to the exterior portion of the studs, and drywall secured to an interior portion of the studs. Cavities between the studs are often filled with a thermal insulation, such as fiberglass batting, cellulose, low density polyurethane foam (e.g., 0.5-2 lbs. per ft.), and the like. While this thermal insulation is generally effective at reducing the thermal transmission through the wall cavities, wood and steel studs are generally less effective at reducing thermal transmission and often provide a path for a thermal transfer between the exterior and interior of the wall (or vice versa), which is referred to herein as “thermal bridging.” Thermal bridging can result in a significant loss of heat (or cold) within the interior of the building, which can be attributed to higher energy costs for maintaining a conditioned interior environment.

While a variety of conventional framing components exist that allow for constructing structural sound buildings, there are few if any framing components which permit the construction structural sound building and at the same time improve the thermal efficiency of the buildings. These features remain a desirable objective.

### SUMMARY

Exemplary embodiments generally provide for polyurethane foam studs, beams, and/or sheathing to replace traditional oriented strand board, plywood, wood, steel, and/or concrete in any building structure whether residential, commercial, or industrial. Exemplary embodiments of the polyurethane foam studs, beams, and/or sheathing can be sufficient strength for supporting a structural load, while at the same time improving the thermal efficiency of buildings to reduce and/or eliminate thermal bridging.

In accordance with embodiments of the present disclosure, a building construction framing component is disclosed that includes an elongate polyurethane foam body having a length, width, thickness, and density. The density of the polyurethane foam body is greater than at least approximately five pounds per cubic foot. In some embodiments, the density of the polyurethane foam body can be greater than at least approximately twenty-five pounds per cubic foot. The polyurethane foam body can be resistant to moisture and/or insect infestations.

In some embodiments, the polyurethane foam body can form at least one of a stud, a beam, or a sheet of sheathing. In some embodiments, the polyurethane foam body as a width of approximately four inches and a thickness of approximately two inches; a width of approximately six inches and a thickness of approximately two inches; a width of approximately eight inches and a thickness of approximately two inches; or a width of approximately ten inches and a thickness of approximately two inches.

In some embodiments, the polyurethane foam body can have a width of approximately four feet and a length of approximately eight feet.

In some embodiments, the polyurethane foam body can have an thermal insulation R-value per inch of approximately 3 to approximately 8.

In accordance with embodiments of the present disclosure, a polyurethane foam composition is disclosed which can be used to form elongate polyurethane bodies. The polyurethane foam composition can include a reaction product of a blend including polyols and an isocyanate, wherein the blend and the isocyanate are mixed according to a ratio by weight of approximately 1:1. The polyols can include at least one of castor oil, polyester polyol, SG355, propanediol, or Arcol E434, wherein the polyols in the composition can have approximately three parts by weight of castor oil; approximately five and a half parts by weight of polyester polyol; approximately thirty-two parts by weight of SG355; approximately fifteen parts by weight of propanediol; and approximately five and a half parts by weight of Arcol E434. The blend can also include a catalyst (e.g., an amine catalyst), a surfactant (e.g., a silicone surfactant), a blowing agent (e.g., water, Ecomate), a fire retardant (TCPP, RB7980, or PHT4DIOL), and/or a reinforcing material (e.g., fiberglass).

Any combination or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

FIG. 1A depicts an exemplary polyurethane foam stud that can be formed in accordance with exemplary embodiments of the present disclosure.

FIG. 1B depicts an exemplary polyurethane foam stud having fiberglass roving embedded therein and that can be formed in accordance with exemplary embodiments of the present disclosure.

FIG. 1C depicts an exemplary polyurethane foam stud having fiberglass mesh embedded therein and that can be formed in accordance with exemplary embodiments of the present disclosure.

FIG. 2A depicts an exemplary sheet of polyurethane foam sheathing that can be formed in accordance with exemplary embodiments of the present disclosure.

FIG. 2B depicts an exemplary polyurethane foam sheathing having fiberglass roving embedded therein and that can be formed in accordance with exemplary embodiments of the present disclosure.

FIG. 2C depicts an exemplary polyurethane foam sheathing having fiberglass mesh embedded therein and that can be formed in accordance with exemplary embodiments of the present disclosure.

FIG. 3 is a flowchart illustrating an exemplary extrusion process for forming polyurethane foam studs, beams, and/or sheathing in accordance with exemplary embodiments of the present disclosure.

FIG. 4 is a flowchart illustrating an exemplary cast molding process for forming polyurethane foam studs, beams, and/or sheathing in accordance with exemplary embodiments of the present disclosure.

FIG. 5 is a flowchart illustrating an exemplary pultrusion process for forming polyurethane foam studs, beams, and/or sheathing in accordance with exemplary embodiments of the present disclosure.

FIG. 6 is an exemplary building formed using the polyurethane foam studs, beams, and sheathing in accordance with exemplary embodiments of the present disclosure.

### DESCRIPTION OF EXEMPLARY EMBODIMENTS

Exemplary embodiments of the present disclosure generally relate to polyurethane foams and polyurethane structural building members including studs, beams, and sheathing that can be used in place of conventional wall studs, beams, and/or sheathing materials, such as wood, oriented strand board (OSB), plywood, steel, concrete, and the like. Utilization of polyurethane foam studs, beams, and sheathing can advantageously eliminate thermal bridging generally associated with studs, beams, and/or sheathing formed from other materials, such as wood, OSB, plywood, steel, concrete, and the like. Exemplary embodiments of the present disclosure can be utilized to advantageously create an energy efficient building structure that may not be achievable using studs, beams, and sheathing formed using conventional materials. Exemplary embodiments of the polyurethane foam studs, beams, and/or sheathing can also advantageously provide improved durability and resilience to environment conditions, such as moisture (e.g., can be mold resistant) and/or can be resistant to termite, carpenter ant, carpenter bee, and other insect infestations that can damage wood-based construction materials.

In exemplary embodiments, the polyurethane foam studs and sheathing can be formed from embodiments of polyurethane foams described herein. Embodiments of the polyurethane foam can be extruded, pultruded, and/or cast in molds to form the polyurethane foam studs, beams, and sheathing. The polyurethane foam studs, beams, and sheathing can be formed to have one or more properties or parameters (e.g., densities, hardness, tensile strength, abrasion resistance, elongation at break percentage, Young's modulus, hydrolysis resistance, tear strength, Bashore rebound, and the like) based on the manner in which the polyurethane foam studs and sheathing is to be utilized. For example, the polyurethane foam studs, beams, and sheathing can have properties or parameters that allow them to be used as load bearing and non-load bearing building or framing materials in residential and/or commercial buildings or structure. The polyurethane foam studs, beams, and sheathing can receive conventional nails and/or screws, which can be driven into the polyurethane foam studs, beams, and sheathing using conventional tools, such that the conventional nails and/or screws can be securely attached to the polyurethane foam studs, beams, and sheathing without requiring special fastening materials or techniques. This allows the polyurethane foam studs, beams, and sheathing to be utilized in a similar manner as studs and sheathing formed by conventional materials, such as wood, OSB, plywood, steel, concrete, and the like.

In exemplary embodiments, one or more reinforcing members may be added to the polyurethane foam before the polyurethane foam cures to, for example, enhance the strength of the polyurethane foam structural building members. For example, in some embodiments, the fiberglass strands, fiberglass roving, fiberglass mesh, chopped fiberglass, and/or glass fibers can be combined with the polyurethane foam, e.g., at the time of manufacture, to form the structural building components. The amount and/or type/form of fiberglass combined with the polyurethane foam can vary based on the application and required properties of the structural building members. For example, fiberglass can form approximately zero percent to approximately ninety percent of the structural building members. In some embodiments, the type/form of fiberglass combined with the polyurethane foam can be based on the manufacturing process utilized to form the structural building members, extrusion, pultrusion, and/or cast molding.

### I. Polyurethane Foam Composition

Exemplary embodiments of polyurethane foam formed in accordance with the present disclosure can have a density from approximately 5 pounds per cubic foot and upwards to 40 pounds per cubic foot (lbs. per cubic ft.) and an R-value per inch of approximately 3 to approximately 8. The polyurethane foam can be used to form building components (i.e., studs, sheathing, and beams) by combining a variety of polyols, amine catalysts, surfactants, fire retardants blowing agents, and/or reinforcement materials; mixing these materials with isocyanate; and extruding, pultruding, or casting the polyurethane foam. The isocyanate reacts with the polyols to produce a reaction product of polyurethane, while the other materials add unique properties that can be advantageously employed to form exemplary embodiments of the polyurethane foam building components (i.e., studs, sheathing, and beams) described herein.

In exemplary embodiments, one or more polyols that can be used to form exemplary embodiments of the polyurethane foam. For example, one or more flexible and rigid polyols as well as one or more polyester polyols can be used. Some non-limiting examples of flexible and rigid polyols that can be utilized include 2 and 3 functional Glycerin initiated Polypropylene Oxide, Castor oil based polyol (flexible). These flexible and rigid polyols can be tipped with an ethylene oxide (EO) or propylene oxide (PO) cap. The base for rigid polyols, which are typically used, are higher in functionality, and include, but are not limited to Amine, Mannich, Sorbitol, and/or Sucrose initiated structures, and/or any other polyols/polyamines suitable for forming polyurethane foam building members (e.g., studs, beams, sheathing). Polyester polyols are typically, but not limited to, high aromatic containing structures. These high aromatic containing structures have nominal functionality with moderate to high hydroxyl numbers, and may carry a certain level of PET content. Linear polyester polyols also can be utilized in accordance with exemplary embodiments of the present disclosure. Some examples of polyester polyols include polyols from such polyesters as p-caprolactones, adipates, succinates, terephthalates, isophthalates, orthophthalates, and the like.

In some embodiments, the one or more polyols can include diols, triols, and macrodiols. The one or more polyols can have a molecular weight of 100, 200, 300, 400, 500, 600, 700, 800 900 or about 1000 Daltons. These values can also be used to define a range such as about 200 to about 1000 Daltons, or about 200 to about 600 Daltons, or about 200 to about 400 Daltons.

One non-limiting example of a polyol that can be used to form the polyurethane foam in accordance with exemplary embodiments of the present disclosure can include polyether polyol. Some examples of polyether polyols can include, but are not limited to polyoxyethylene glycol, polyoxypropylene glycol, polyoxybutylene glycol, polytetramethylene glycol, block copolymers, for example, combinations of polyoxypropylene and polyoxyethylene glycols, poly-1,2-oxybutylene and polyoxyethylene glycols and copolymer glycols prepared from blends or sequential addition of two or more alkylene oxides.

Any suitable isocyanate can be used to react with the polyols to produce the polyurethane foam. The isocyanate can have a 5 or 6 membered ring, substituted or unsubstitued, e.g., a 5 or 6 membered aromatic ring. Some examples of isocyanates that can be used include, but are not limited to 1,4-diisocyanatobenzene, 1,3-diisocyanato-o-xylene, 1,3-diisocyanato-p-xylene, 1,3-diisocyanato-m-xylene, 2,4-diisocyanato-l-chlorobenzene, 2,4-diisocyanato-l-nitrobenzene, 2,5-diisocyanato-1-nitrobenzene, m-phenylene diisocyanate, 2,4 toluene diisocyanate, 2,6-toluene diisocyanate, mixtures of 2,4- and 2,6-toluene diisocyanate, hexahydrotoluene diisocyanate, 1,5-naphthalene diisocyanate, 1-methoxy-2,4-phenylene diisocyanate, 2,2-, 2,4- and 4,4′-biphenylmethane diisocyanate, methyl, diphenyl diisocyanate, 4,4′-biphenylene diisocyanate, 3,3′-dimethyl-4,4′-diphenylmethane diisocyanate, 3,3′-4,4′-diphenylmethane diisocyanate, and 3,3′-dimethyldiphenylmethane-4,4′-diisocyanate, 2,2-, 2,4-, 4,4-, and polymer diphenylmethane diisocyanate as well as pre-polymers made thereof; the triisocyanates such as 4,4′,4″-triphenylmethane triisocyanate, polymethylene polyphenylene polyisocyanate, and 2,4,6-toluene triisocyanate; and the tetraisocyanates such as 4,4-dimethyl-2,2′-5,5′-diphenylmethane tetraisocyanate.

In some embodiments, the isocyanate can have a molecular weight of 100, 200, 300, 400, 500, 600, 700, 800 900 or about 1000 Daltons. These values can also be used to define a range such as about 200 to about 1000 Daltons, or about 200 to about 600 Daltons, or about 200 to about 400 Daltons.

Any suitable polyurethane catalysts can be used in the formation of exemplary embodiments of the polyurethane foam described herein. Some non-limiting examples of polyurethane catalysts that can be used to form exemplary embodiments of the polyurethane foam of the present disclosure include a variety of amine and metallic based molecules. The Amines are represented in 2 groups, and are commonly provided as primary or tertiary products. Tertiary amines can include, but are not limited to triethylenediamine (TEDA, 1,4-diazabicyclo octane or Dabco 33LV), N-methylmorpholine, N-ethylmorpholine, diethylethanolamine, N-cocomorpholine, dimethylcyclohexylamine (DMCHA) 1-methyl-4-dimethylaminoethylpiperazine, methoxypropyldimethylamine, N,N,N′-trimethylisopropyl propylenediamine, 3-diethylaminopropyldiethylamine, dimethylbenzylamine, and/or any other primary catalysts suitable for forming polyurethane foam building members (e.g., studs, beams, and sheathing). Primary amines can include, but are not limited to dimethylethanolamine (DMEA)/Bis-(2-dimethylaminoethyl)ether (commonly known as (A-1)) and/or any other primary catalysts suitable for forming polyurethane foam building members (e.g., studs, beams, and sheathing). Other suitable catalysts can include, for example, dibutyltin dilaurate, dibutyltin d/acetate, stannous chloride, dibutyltin di-2-ethyl hexanoate, and stannous oxide.

Some examples of surfactants that can be utilized include polydimethylsiloxane-polyoxyalkylene block copolymers, silicone-based surfactants, silicone oils, nonylphenol ethoxylates, and/or any other surfactants suitable for forming polyurethane foam building members (e.g., studs, beams, and sheathing).

Some examples of fire retardants that can be utilized include, but are not limited to Halogenated polyether polyol, a mixture of diester/ether diol of tetrabromophthalic anhydride and phosphate, huntite, hydromagnesite, aluminum hydroxide, magnesium hydroxide, and/or any other fire retardants suitable for forming polyurethane foam building members (e.g., studs, beams, and sheathing).

Some examples of blowing agents that can be utilized include CFCs, HCFCs, hydrocarbons, liquid carbon dioxide (CO2), isocyanate and water, nitrogen-based materials, sodium bicarbonate, atmosphere (e.g., by frothing), sodium chloride crystals, vermiculite (or other reticulated materials), and/or any other blowing agents suitable for forming polyurethane foam building members (e.g., studs, beams, and sheathing). A few common Brand names representing the above that are common Honeywell's 245fa, Solkane 365/227, Ecomate, 141b, and others.

The polyol blend can contain about 25, 30, 35, 40, 45, 50, 55, 60, 65, 70, 75, 80, 85 or about 90 weight percent of the one or more polyols. These values can also be used to define a range, such as about 25 to about 75 weight percent, about 30 to about 50 weight percent, about 60 to about 65 weight percent, about 55 to about 70 weight percent or about 60 to about 70 weight percent.

The polyol blend can contain about 2, 3, 4, 5, 6, 7, 8, 9 or about 10 weight percent of one or more catalysts, e.g., amine catalysts. These values can also be used to define a range, such as about 4 to about 5 weight percent, or about 3 to about 6 weight percent or about 2 to about 7 weight percent.

The polyol blend can contain about 2, 3, 4, 5, 6, 7, 8, 9, 10, 11, 12, 13,14 or about 15 weight percent of one or more surfactants, e.g., silicone surfactants. These values can also be used to define a range, such as about 6 to about 7 weight percent, or about 5 to about 8 weight percent or about 4 to about 9 weight percent.

The polyol blend can contain about 15, 16, 17, 18, 19, 20, 21, 22, 23, 24, 25, 26, 27, 28, 29, 30, 31, 32, 33, 34 or about 35 weight percent of one or more fire retardants. These values can also be used to define a range, such as about 23 to about 27 weight percent, or about 20 to about 30 weight percent or about 17 to about 33 weight percent.

The polyol blend can contain about 0.02, 0.04, 0.06, 0.08, 0.1, 0.2, 0.3, 0.4, 0.5, 0.6, 0.7, 0.8, 0.9 or about 1 weight percent of one or more blowing agents. These values can also be used to define a range, such as about 0.04 to about 0.06 weight percent, or about 0.02 to about 0.08 weight percent.

The polyol blend can be combined with the isocynate(s) or a solution of isocyanate(s) in about a 1:1 ratio, 0.9:1. 1:0.9, 0.8:1, 1:0.8, 0.7:1, 1:0.7, 0.6:1 1:0.6, 0.5:1 or about 1:0.5 ratio based on equivalent weights (OH groups for polyols and NCO groups for isocyanates).

In some embodiments, the polyurethane foam can contain about 30, 35, 40, 45, 50, 55, 60, 65, or about 70 weight percent of the isocynate(s) or a solution of isocynate(s). These values can also be used to define a range, such as about 30 to about 70 weight percent, or about 40 to about 60 weight percent.

The cured polyurethane foam structural building members can have a hardness (durometer value) measured according to the ASTM D2240 standard/specification of about 70, 75, 80, 85, 90, 95, or about 100 on the Shore A scale. These values can also be used to define a range, such as about 70 to about 100 on the Shore A scale, about 80 to about 100 on the shore A scale, or about 75 to about 95 on the Shore A scale. Likewise, the cured polyurethane foam structural building members can have a hardness (durometer value) measured according to the ASTM D2240 standard/specification of about 25, 30, 35, 40, 45, 50, 55, 60, 65, 70, 75, 80, 85, or about 90 on the Shore D scale. These values can also be used to define a range, such as about 25 to about 90 on the Shore D scale, about 35 to about 85 on the shore D scale, or about 50 to about 85 on the Shore D scale.

The cured polyurethane foam structural building members can have a tensile strength measured according to the ASTM D412 standard/specification of about 1,500, 2,000, 2,500, 3,000, 3,500, 4,000, 4,500, 5,000, 5,500, 6,000, 6,500, 7,000, 7,500, 8,000, or about 8,500 psi. These value can also be used to define a range, such as about 2,000 to about 8, 000 psi, about 4,000 to about 8,500 psi, or about 6,000 to about 8,500 psi.

The cured polyurethane foam structural building members can have an average water absorption measured according to ASTM D570 of about 0, 5, 10, 15, 20, 25, 30, 35, 40, or about 45 percent. These value can also be used to define a range, such as about 0 to about 40 percent, about 0 to about 20 percent, about 0 to about 10 percent (e.g., less than or equal to about 10 percent), or about 0 to about 5 percent (e.g., less than or equal to 5 percent).

The cured polyurethane foam structural building members can have an abrasion resistance measured according to the ASTM D1044 standard/specification of about 10, 30, 50, 70, 90, 110, 130, 150, 170, 190, 210, 230, 250, 270, 290, 310, 330, 350, or about 370 mg CS22 wheel, 1000 gr weight, 1000 revolutions. These values can also be used to define a range, such as about 10 to about 350 mg CS22 wheel, 1000 gr weight, 1000 revolutions, about 30 to about 200 mg CS22 wheel, 1000 gr weight, 1000 revolutions, or about 50 to about 150 mg CS22 wheel, 1000 gr weight, 1000 revolutions.

The cured polyurethane foam structural building members can have an elongation at break measured according to the ASTM D412 standard/specification of about 25, 50, 75, 100, 125, 150, 175, or about 200 percent. These values can also be used to define a range, such as about 25 to about 200 percent, about 50 to about 150 percent, or about 100 to about 200 percent.

The cured polyurethane foam structural building members can have a Bashore rebound according to the ASTM D2632 standard/specification of 30, 35, 40, 45, 50, 55, 60, 65, or 70 percent. These values can also be used to define a range, such as about 30% to about 70%, about 35 to about 60%, or about 40% to about 50%.

The cured polyurethane foam structural building members can have a tear strength according to the ASTM D624 standard/specification, using a Die C specimen, of 80, 90, 100, 110, 120, 130, 140, 150, 160, 170, 180, 190, 200, 210, 220, 230, 240, 250, 260, 270, 280, 290, 300, 310, 320, 330, 340, or 350 pli. These values can also be used to define a range, such as about 80 pli to 350 pli, about 150 pli to about 350 pli, or about 250 pli to about 350 pli.

An example formulation of an exemplary embodiment of a polyurethane foam in accordance with the present disclosure that can be used to form studs, beams, and/or sheets of sheathing, described herein, with an average density of polyurethane foam of approximately 25 lbs. per cubic foot and an R-value per inch of approximately 3 to approximately 8 is provided in Table 1. While the below formulation can result in a polyurethane foam having one or more of the properties described herein including, for example, an average density of approximately 25 lbs. per foot, it will be recognized that variations, modifications, and/or additives can be used to achieve different densities of the polyurethane foam as well as to achieve different physical properties of the polyurethane foam. As one example, the form a polyurethane foam having an average density of approximately 6 lbs. per cubic ft., approximately 0.35 parts by weight (“pbw”) of water can be added to 100 pbw of the formulation, and to form a density between 6 lbs. per cubic foot and 25 lbs. per cubic foot, between approximately zero and approximately 0.35 pbw of water can be added to the below formulation. As another example, the density (and other physical properties) of the polyurethane foam can be effected by molding the below formulation under a vacuum. While Table 1 provides specified values for various elements/components of an exemplary formulation, the values can be approximate values and/or vary within a range, such as, for example, +/−1%, +/−2%, +/−3%, +/−4%, +/−5%, +/−6%, +/−7%, +/−8%, +/−9%, and/or +/−10%.

TABLE 1
EXEMPLARY POLYURETHANE FOAM COMPOSITION
USED TO FORM A STUD/BEAM OR SHEET OF SHEATHING
WHEN MIXED 1:1 BY VOLUME WITH ISOCYANATE

| Material | Amount | | |
|---|---|---|---|
| Polyols such as Castor Oil/Terate | Castor Oil | 3 | pbw |
| 2031/SG355/Propanediol/Arcol E434 | Polyester Polyol | 5.4 | pbw |
| | SG355 | 35.26 | pbw |
| | Propanediol | 15.0 | pbw |
| | Arcol E434 | 5.4 | pbw |
| Amine catalysts such as BL-11/ | BL-11 | 0.75 | pbw |
| Polycat 30/K-15 | Polycat 30 | 3.20 | pbw |
| | K15 | 0.25 | pbw |
| Silicone surfactants such as Silstab | Silstab 2760 | 0.68 | pbw |
| 2760/Evonik 8870 | Nonyl-phenol | 6.07 | pbw |
| Nonyl-phenol NP-9 | | | |
| Fire retardants such as TCPP/RB7980 | TCPP | 20.0 | pbw |
| OR PHT4DIOL | RB7980 | 5.0 | pbw |
| Blowing agents such as water, | Ecomate | <1 | pbw |
| Ecomate, 365-227, 245FA | | | |

Another example formulation of an exemplary embodiment of a polyurethane foam in accordance with the present disclosure that can be used to form studs, beams, and/or sheets of sheathing, described herein, having one or more of the properties described herein is provided in Table 2. While Table 2 provides specified values for various elements/components of an exemplary formulation, the values can be approximate values and/or vary within a range, such as, for example, +/−1%, +/−2%, +/−3%, +/−4%, +/−5%, +/−6%, +/−7%, +/−8%, +/−9%, and/or +/−10%.

TABLE 2
EXEMPLARY POLYURETHANE FOAM COMPOSITION
USED TO FORM A STUD/BEAM OR SHEET OF SHEATHING

| Product Name | Parts | % |
|---|---|---|
| TCPP | 20.00 | 20.00 |
| Castor Oil | 3.00 | 3.00 |
| Terate 2031 | 5.40 | 5.40 |
| SG355 | 35.26 | 35.26 |
| water | 0.00 | 0.00 |
| NP-9 | 6.07 | 6.07 |
| 8870 | 0.68 | 0.67 |
| PC30 | 3.20 | 3.20 |
| BL-11 | 0.75 | 0.75 |
| k-15 | 0.25 | 0.25 |
| Propanediol | 15.00 | 15.00 |
| E434 | 5.40 | 5.40 |
| RB7980 | 5.00 | 5.00 |

In some embodiments, one or more reinforcing materials can be added to the polyurethane foam formulation to strengthen or reinforce the polyurethane studs, beams, and/or sheets of sheathing formed using the polyurethane foam formulation. As one example, fiberglass can be added to exemplary embodiments of the polyurethane foam formation. As another example, exemplary embodiments of the polyurethane foam formulations can be processed to form a polyurethane foam that completely surrounds one or more embedded reinforcing members, such as fiberglass and/or metallic members formed from, for example, aluminum or steel. For example, the reinforcing members can be formed from a fiberglass mesh, strands of fiberglass, fiberglass roving, a metal mesh, metal wire. In some embodiments, the polyurethane foam studs, beams, and sheathing can be devoid of any metallic reinforcing members.

### II. Studs And Beams

FIG. lA depicts an exemplary polyurethane foam stud 100A that can be formed in accordance with exemplary embodiments of the present disclosure (e.g., using the exemplary formulation provided in Table 1 or Table 2 or variations and/or equivalents thereof). The stud can have an elongate body 102 extending along a longitudinal axis L from a first end 104 to a second end 106. A length 108 of the stud 100A can measured along the longitudinal axis L between the first end 104 and the second end 106. The body 102 can have sides 110 and 112 and edges 114, where the dimensions of the sides 110 and 112 are generally greater than the dimension of the edges 114. A width 118 of the stud 100A can be measured between the edges 114 along a first transverse axis T₁ that is perpendicular to the longitudinal axis L. A thickness 120 of the stud can be measured between the sides 110 and 112 along a second transverse axis T₂ that is perpendicular to the longitudinal axis L and the first transverse axis T₁. A cross-section of the body 102 can have a generally rectangular shape with a perimeter defined by the sides 110 and 112 and the edges 114. While Figure depicts an exemplary stud 100A, those skilled in the art will recognize that beams formed in accordance with exemplary embodiments of the present disclosure can have a similar structure, but may have greater dimensions than the studs and/or higher densities than the studs.

The polyurethane foam studs can be utilized in construction of vertically oriented building elements, such as interior and/or exterior walls of a building, as well as to form rough openings in the interior and/or exterior walls of a building. The polyurethane foam beams can be utilized in general horizontal or acute angled building elements, such as floor joists, rafters, support beams, and the like. Exemplary embodiments of the polyurethane foam studs and/or beams can provide improved thermal insulation as compared to conventional framing materials, and can have an R-value per inch of, for example, approximately 3 to approximately 8. Exemplary embodiments of the polyurethane foam studs and/or sheathing can also advantageously provide improved durability and resilience to environment conditions, such as moisture (e.g., can be mold resistant) and/or can be resistant to termite, carpenter ant, carpenter bee, and other insect infestations that can damage wood-based construction materials.

As described herein, conventional fasteners, such as nails and/or screws, can be used to attach studs and/or beams to each other and/or to attach sheathing to the studs and/or beams. In exemplary embodiments, the polyurethane foam studs and/or beams can hold conventional fasteners to facilitate attachment of other members or structures thereto in a similar manner as studs and/or beams formed from convention materials, such as wood.

The polyurethane foam wall studs and beams can be formed with varying dimensions of length width, and thickness. For example, in exemplary embodiments, the polyurethane foam studs and/or beams can be formed as 2″×4″ (a thickness of approximately 2 inches and a width of approximately 4 inches), 2″×6″, 2″×8″, 2″×10″, 2″×12″, and/or any other suitable dimensions for use in the construction of a building. As generally understood to those skilled in the art stock 2×4 lumber can have a thickness of approximately 1.5 inches and a width of approximately 3.5 inches, stock 2×6 lumber can typically have a thickness of approximately 1.5 inches and a width of approximately 5.5 inches, stock 2×8 lumber can have a thickness of approximately 1.5 inches and a width of approximately 7.5 inches, stock 2×10 lumber can have a thickness of approximately 1.5 inches and a width of approximately 9.5 inches, and stock 2×12 lumber can have a thickness of approximately 1.5 inches and a width of approximately 11.5 inches, and the polyurethane studs can be formed to have these typical dimensions or can have different dimensions. The length of the studs and/or beams can be, for example, 4 ft., 6 ft., 8 ft., 10 ft., 12 ft., 14 ft., and/or any other lengths suitable for forming exemplary embodiments of the polyurethane foam studs and/or beams. The polyurethane foam studs and/or beams can be formed with densities that provide a sufficient structure for supporting a structural load and/or receiving and holding nails and screws. For example, the polyurethane foam studs and/or beams can be formed to have densities of approximately 5 pounds (lbs.) per cubic foot (ft.) to approximately 40 lbs. per cubic ft. or greater, and can be utilized to replace studs formed of conventional construction materials, as described herein. For example, in some embodiments, the studs and/or beams may be formed to have densities of 5 lbs., 10 lbs., 15 lbs., 20 lbs., 25 lbs., 30 lbs., 35 lbs., 40 lbs. per cubic ft., and the like. The density of the polyurethane foam studs and/or beams can be determined based on the application for which the polyurethane foam studs and/or beams. For example, in generally, as the density of the polyurethane foam studs and/or beams is increased, the physical properties of the polyurethane foam studs and/or beams improves (although the cost associated with the studs and/or beams can also increase).

As described herein, in addition to a density of the polyurethane foam, the polyurethane foam studs can have a hardness (durometer value) measured according to the ASTM D2240 standard/specification of about 70, 75, 80, 85, 90, 95, or about 100 on the Shore A scale, about 25, 30, 35, 40, 45, 50, 55, 60, 65, 70, 75, 80, 85, or about 90 on the Shore D scale, or one or more ranges of hardness, such as one or ranges of hardness described herein. The polyurethane foam studs can have a tensile strength measured according to the ASTM D412 standard/specification of about 1,500, 2,000, 2,500, 3,000, 3,500, 4,000, 4,500, 5,000, 5,500, 6,000, 6,500, 7,000, 7,500, 8,000, or about 8,500 psi, or one or more ranges of tensile strength, such one or more ranges of tensile strength described herein. The polyurethane foam studs can have an average water absorption measured according to ASTM D570 of about 0, 5, 10, 15, 20, 25, 30, 35, 40, or about 45 percent, or one or more ranges of average percent water absorption, such as one or more ranges of average percent water absorption described herein. The polyurethane foam studs can have an abrasion resistance measured according to the ASTM D1044 standard/specification of about 10, 30, 50, 70, 90, 110, 130, 150, 170, 190, 210, 230, 250, 270, 290, 310, 330, 350, or about 370 mg CS22 wheel, 1000 gr weight, 1000 revolutions, or one or more ranges of abrasion resistance, such as one or more ranges of abrasion resistance described herein. The polyurethane foam studs can have an elongation at break measured according to the ASTM D412 standard/specification of about 25, 50, 75, 100, 125, 150, 175, or about 200 percent, or one or more ranges of elongation at break, such as one or more ranges of elongation at break described herein.

The polyurethane foam studs can support structural loads that are comparable and/or greater than the structural loads that can be supported by conventional wood wall studs. The strength of the polyurethane foam studs can be determined, at least in part, by the properties of the polyurethane foam utilized to form the polyurethane foam studs, the properties of any reinforcing members combined with the polyurethane foam, and/or cross-sectional thickness of the polyurethane foam studs, such that different combinations of properties and cross-sectional thickness can be utilized to meet or exceed the structural properties of wood studs. As one non-limiting example, when exemplary embodiments of the polyurethane foam studs are used in load bearing application, the polyurethane foam studs can have one or more properties described herein, such as a density that is, for example, approximately 25 lbs. per cubic foot or greater, although the density of the polyurethane foam stud used in load bearing application can be determined based on the load being supported (e.g., as determined by an engineer, architect, or building code) and the dimensions of the stud such that polyurethane foam studs having a density that is less than 25 lbs. per cubic foot can used in load bearing applications.

As described herein, in some embodiments, the polyurethane foam stud and/or beams can include reinforcements disbursed throughout or embedded therein. As one non-limiting example, during formation of the polyurethane foam studs and/or beams, fiberglass can be combined with or mixed into the polyurethane foam composition, such that when the polyurethane foam composition is processed to form the polyurethane foam studs and/or beams, the fiberglass strengthens and reinforces the polyurethane foam studs and/or beams. As another non-limiting example, the polyurethane foam studs and/or beams can be formed such that the polyurethane foam completely surrounds a reinforcing member formed from, for example, a metal (e.g., aluminum or steel) or other material, such that the polyurethane foam thermally isolates the metal or other material, where the reinforcing member extends along is a longitudinal length of the stud or beam.

In exemplary embodiments, one or more reinforcing members may be added to the polyurethane foam studs before the polyurethane foam studs cures to, for example, enhance the strength of the polyurethane foam structural building members. As one example, in some embodiments, the fiberglass strands, chopped fiberglass, and/or glass fibers can be added to the polyurethane mixture prior to or during the formation of the studs such that the fiberglass is embedded and distributed in the cured polyurethane foam. As another example, fiberglass strands, fiberglass roving, and/or fiberglass mesh can be combined with the polyurethane foam prior to curing of the polyurethane foam such that when the polyurethane foam cures, the fiberglass strands, fiberglass roving, and/or fiberglass mesh is embedded in and/or integrally formed with the cured polyurethane foam. The amount and/or type/form of fiberglass combined with the polyurethane foam can vary based on the application and required properties of the structural building members. For example, fiberglass can form approximately zero percent to approximately ninety percent of the studs. In some embodiments, the type/form of fiberglass combined with the polyurethane foam can be based on the manufacturing process utilized to form the structural building members, extrusion, pultrusion, and/or cast molding.

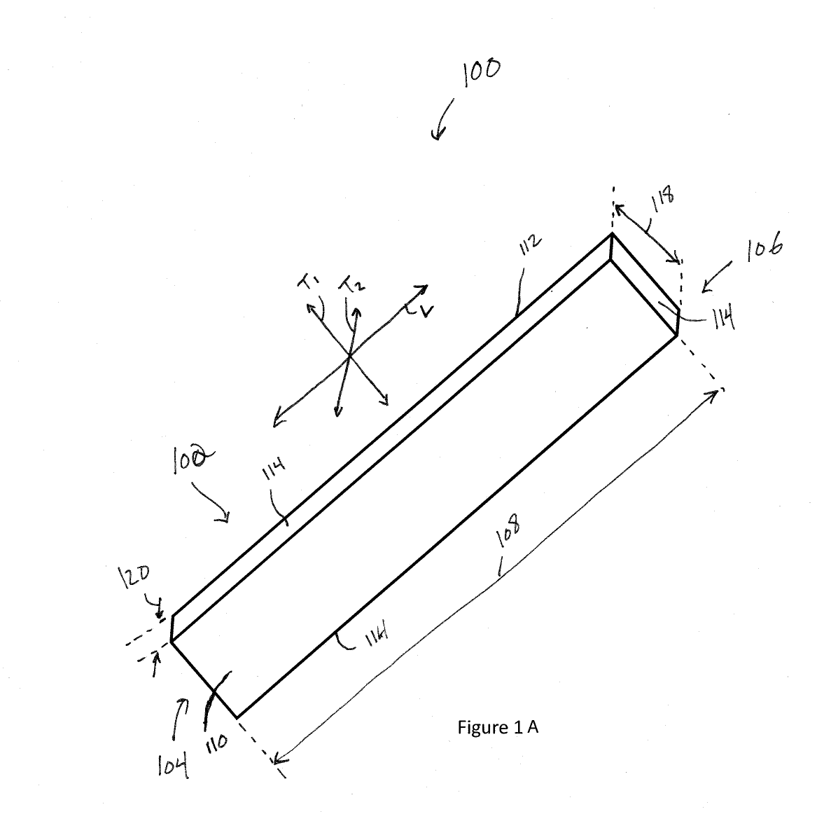

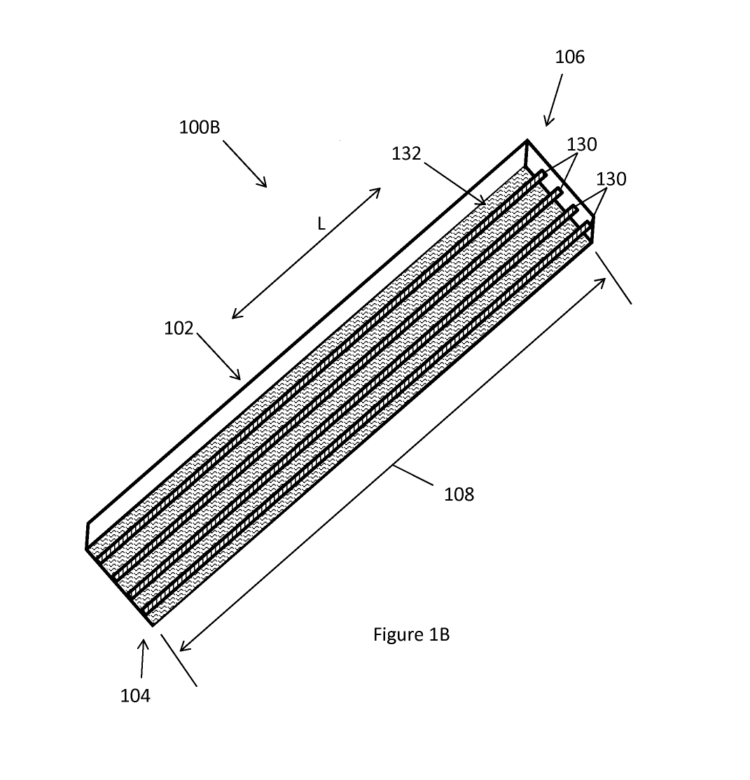

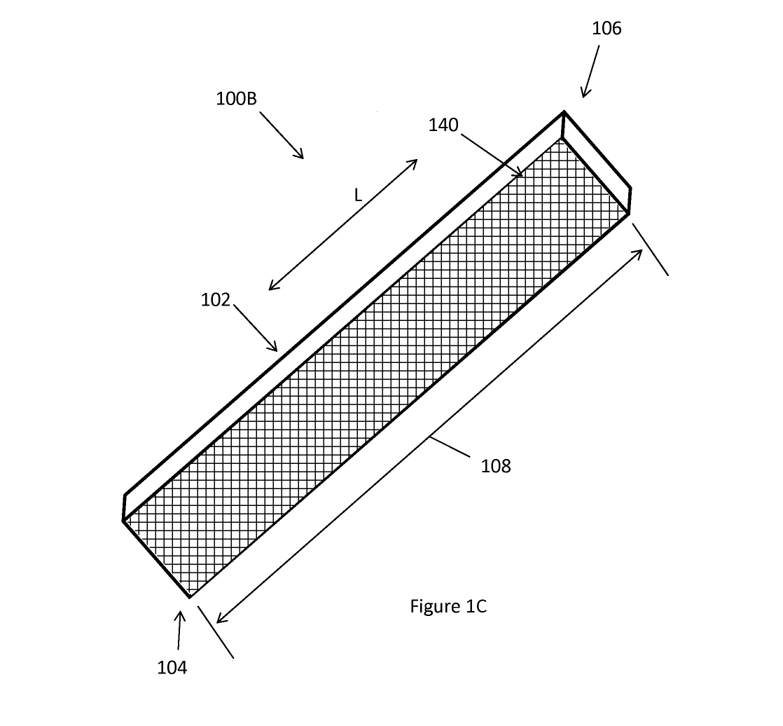

FIG. 1B shows a cross section of an example polyurethane foam stud 100B having an elongated body 102 formed with fiberglass roving 130 embedded therein. As shown in FIG. 1B, the fiberglass roving 130 can extend along the longitudinal axis L a portion or entire length 108 of the body 102 from a first end 104 of the body to a second end 108. The fiberglass roving 130 can be founded by separate (continuous) strands of fiberglass. In some embodiments, in addition to, or in the alternative of the fiberglass roving 130, individual strands 132 of fiberglass can be distributed throughout the body 102.

FIG. 1C shows a cross section of an example polyurethane foam stud 100C having the elongated body 102 formed with fiberglass mesh 140 embedded therein. As shown in FIG. 1C, the fiberglass mesh can extend along the longitudinal axis L a portion or entire length 108 of the body 102 from the first end 104 of the body to the second end 106. The fiberglass mesh 240 can be founded by crisscrossing strands of fiberglass and/or by fiberglass roving. In some embodiments, in addition to, or in the alternative of the fiberglass mesh individual strands of fiberglass can be distributed throughout the body 102.

In some embodiments, the polyurethane foam studs and/or beams can include perforations or the like. The perforations can be formed in the studs and/or beams to reduce the weight of the studs and/or beams and to reduce the amount of material necessary to form studs and/or beams.

### III. Sheathing

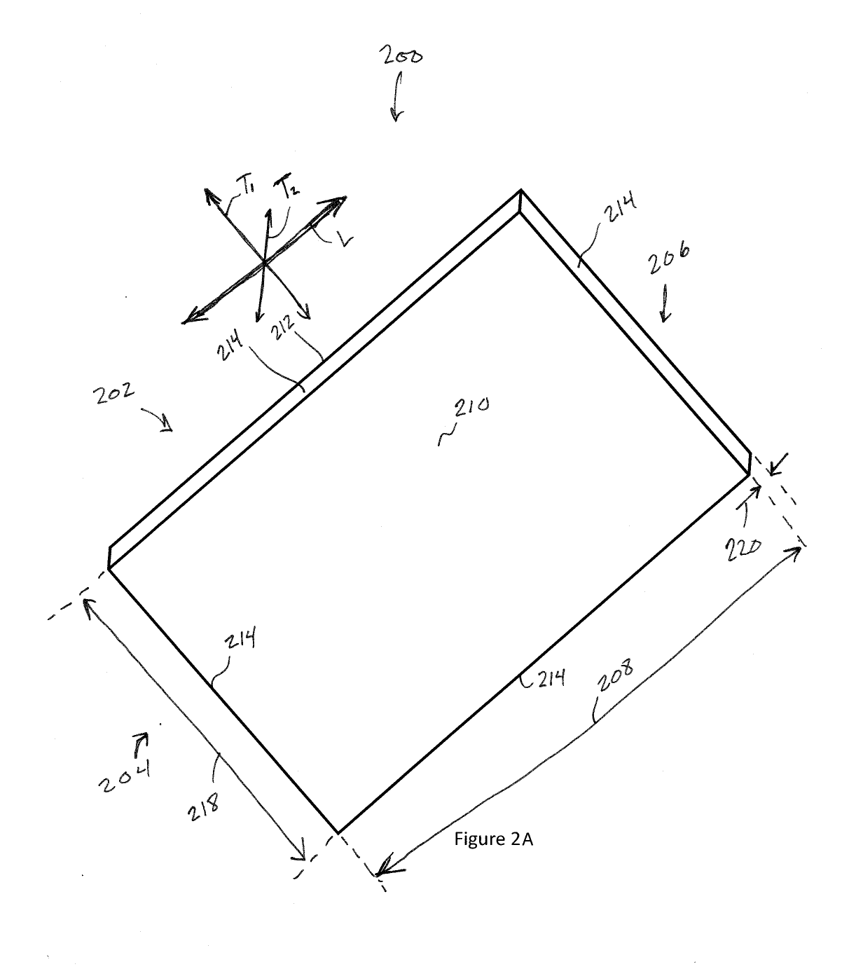

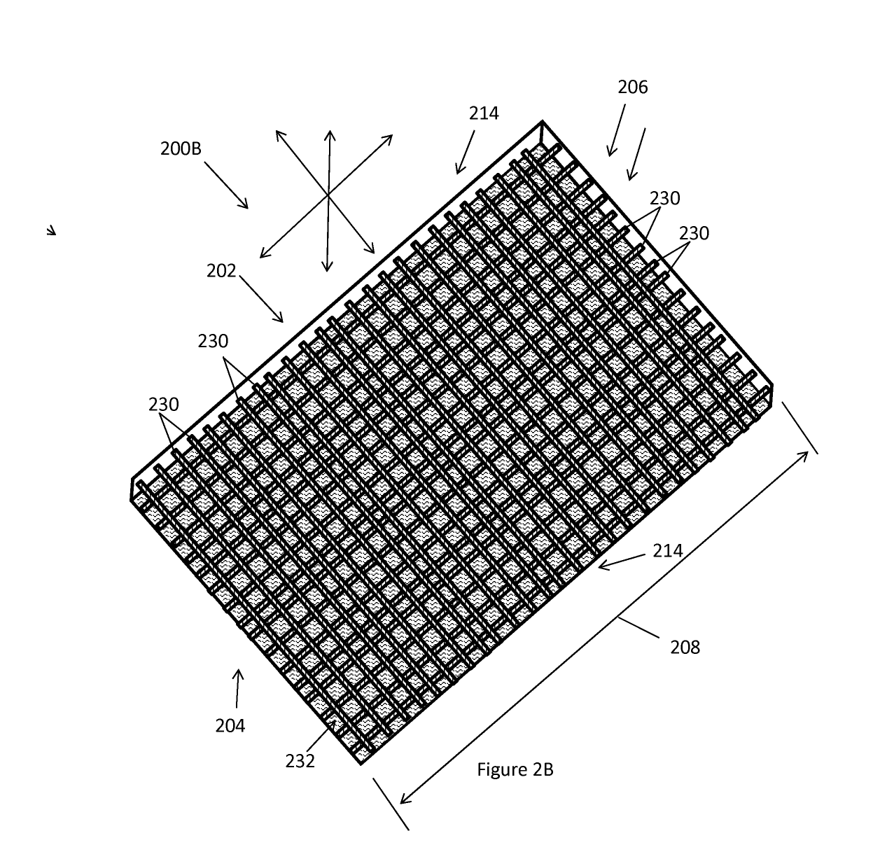

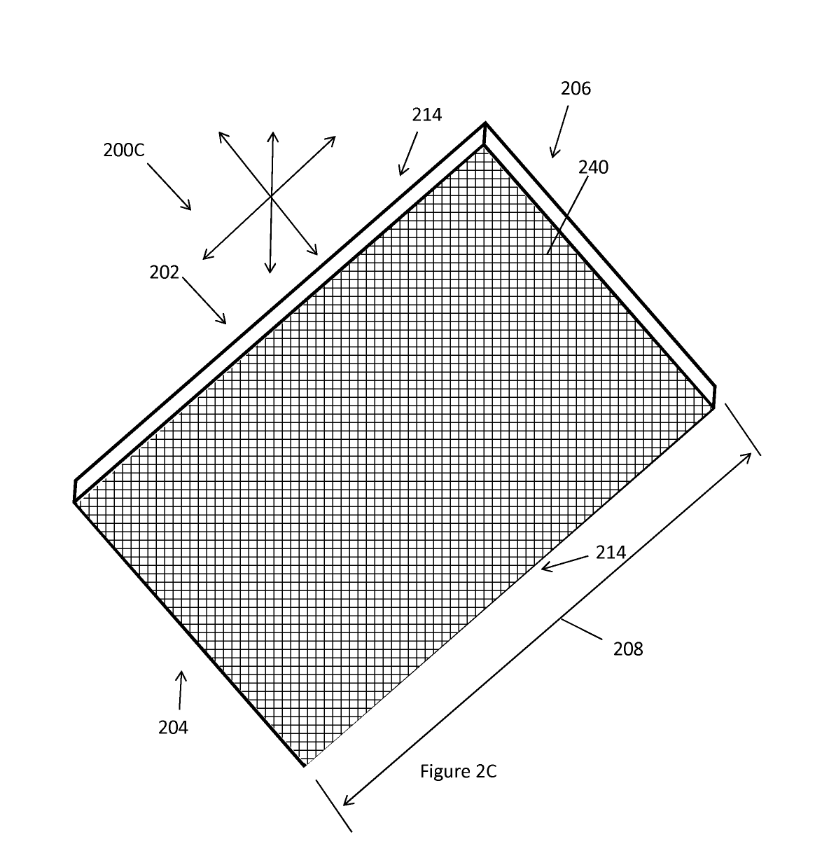

FIG. 2A depicts an exemplary sheet of polyurethane foam sheathing 200A that can be formed in accordance with exemplary embodiments of the present disclosure (e.g., using the exemplary formulation provided in Table 1 or Table 2 or variations and/or equivalents thereof). The sheathing can have an elongate planar body 202 extending along a longitudinal axis L from a first end 204 to a second end 206. A length 208 of the sheathing 200A can measured along the longitudinal axis L between the first end 204 and the second end 206. The body 202 can have planar sides 210 and 212 and planar edges 214, where the dimensions of the sides 210 and 212 are generally greater than the dimension of the edges 214. A width 218 of the sheathing 200A can be measured between the edges 214 along a first transverse axis T₁ that is perpendicular to the longitudinal axis L. A thickness 220 of the sheathing can be measured between the sides 210 and 212 along a second transverse axis T₂ that is perpendicular to the longitudinal axis L and the first transverse axis T₁. A cross-section of the body 202 can have a generally rectangular shape with a perimeter defined by the sides 210 and 212 and the edges 214.

The sheathing 200A can be utilized to cover the exterior framing of a building. For example, the sheathing 200A can be fastened to the studs that form an exterior frame of a building, can be fastened to the rafters of building to form a roof of the building, and/or can be fastened to beams/joists to form subfloors or floors. Exemplary embodiments of the polyurethane foam sheathing can provide improved thermal insulation as compared to conventional framing materials, and can have an R-value per inch of, for example, approximately 3 to approximately 8. Exemplary embodiments of the polyurethane foam studs and/or sheathing can also advantageously provide improved durability and resilience to environment conditions, such as moisture (e.g., can be mold resistant) and/or can be resistant to termite, carpenter ant, carpenter bee, and other insect infestations that can damage wood-based construction materials.

As described herein, conventional fasteners can be used to attached the sheathing to the framing, such as nails and/or screws. In exemplary embodiments, the polyurethane foam sheathing can hold fasteners to facilitate attachment of siding and shingles to the sheathing 200A such that conventional fasteners, such as nails and/or screws can be used to attach and secure siding and shingles directly to the sheathing 200A in a similar manner as sheathing formed from convention materials, such as plywood and OSB and without requiring special fastening devices or techniques.

The polyurethane foam sheathing can be formed in sheet having varying dimensions of length, width and thickness. For example, in exemplary embodiments, the polyurethane foam sheathing can be formed as 4′×8′ sheets (a width of approximately 4 feet and a length of approximately 8 feet), 4′×4′ sheets, 8′×8′ sheets, and/or any suitable L×W dimensions for use in the construction of a building. The thickness of the sheets of sheathing can be for example, approximately ¼in., approximately ½in., approximately ¾in., and/or any other thicknesses suitable for forming exemplary embodiments of the polyurethane foam sheathing. The sheets polyurethane foam sheathing can be formed with densities that provide a sufficient structure for supporting a structural load and/or receiving and holding nails and screws. For example, the sheets of polyurethane foam sheathing can be formed to have densities of approximately 5 lbs. per cubic ft. to approximately 40 lbs. per cubic ft., and can be utilized to replace sheathing formed of convention construction materials, as described herein. For example, in some embodiments, the sheets of sheathing can be formed to have densities of 5 lbs, 10 lbs., 15 lbs., 20 lbs., 25 lbs., 30 lbs., 35 lbs., and/or 40 lbs. per ft.

As described herein, in addition to a density of the polyurethane foam, the polyurethane foam structural building members can have a hardness (durometer value) measured according to the ASTM D2240 standard/specification of about 70, 75, 80, 85, 90, 95, or about 100 on the Shore A scale, about 25, 30, 35, 40, 45, 50, 55, 60, 65, 70, 75, 80, 85, or about 90 on the Shore D scale, or one or more ranges of hardness, such as one or ranges of hardness described herein. The polyurethane foam structural building members can have a tensile strength measured according to the ASTM D412 standard/specification of about 1,500, 2,000, 2,500, 3,000, 3,500, 4,000, 4,500, 5,000, 5,500, 6,000, 6,500, 7,000, 7,500, 8,000, or about 8,500 psi, or one or more ranges of tensile strength, such one or more ranges of tensile strength described herein. The polyurethane foam sheathing can have an average water absorption measured according to ASTM D570 of about 0, 5, 10, 15, 20, 25, 30, 35, 40, or about 45 percent, or one or more ranges of average percent water absorption, such as one or more ranges of average percent water absorption described herein. The polyurethane foam sheathing can have an abrasion resistance measured according to the ASTM D1044 standard/specification of about 10, 30, 50, 70, 90, 110, 130, 150, 170, 190, 210, 230, 250, 270, 290, 310, 330, 350, or about 370 mg CS22 wheel, 1000 gr weight, 1000 revolutions, or one or more ranges of abrasion resistance, such as one or more ranges of abrasion resistance described herein. The polyurethane foam sheathing can have an elongation at break measured according to the ASTM D412 standard/specification of about 25, 50, 75, 100, 125, 150, 175, or about 200 percent, or one or more ranges of elongation at break, such as one or more ranges of elongation at break described herein.

The polyurethane foam sheathing can support structural loads that are comparable and/or greater than the structural loads that can be supported by conventional sheathing. The strength of the polyurethane foam sheathing can be determined, at least in part, by the density of the polyurethane foam utilized to form the polyurethane foam sheathing and/or the cross-sectional thickness of the polyurethane foam sheathing, such that different combinations of density and cross-sectional thickness can be utilized to meet or exceed the structural properties of sheathing formed using conventional materials. As one non-limiting example, the polyurethane foam sheathing can have a density that is, for example, approximately 5 lbs. per cubic foot or greater, although the density of the polyurethane foam sheathing used in a particular application can be determined based on the strength necessary (e.g., as determined by an engineer, architect, or building code).

As described herein, in some embodiments, the polyurethane foam sheathing can include reinforcements disbursed throughout or embedded therein. As one non-limiting example, during formation of the polyurethane foam sheathing, fiberglass can be mixed into the polyurethane foam composition, such that when the polyurethane foam composition is processed to form the polyurethane foam sheathing, the fiberglass strengthens and reinforces the polyurethane foam sheathing and/or beams. As another non-limiting example, the polyurethane foam sheathing can be formed such that the polyurethane foam sandwiches a reinforcing member, such as a plastic sheet or other material, such that the polyurethane foam thermally isolates the reinforcing member.

In exemplary embodiments, fiberglass may be added to the polyurethane foam sheathing before the polyurethane foam sheathing cures to, for example, enhance the strength of the polyurethane foam structural building members. As one example, in some embodiments, the fiberglass strands, chopped fiberglass, and/or glass fibers can be added to the polyurethane mixture prior to or during the formation of the sheathing such that the fiberglass is embedded and distributed in the cured polyurethane foam. As another example, fiberglass strands, fiberglass roving, and/or fiberglass mesh can be combined with the polyurethane foam prior to curing of the polyurethane foam such that when the polyurethane foam cures, the fiberglass strands, fiberglass roving, and/or fiberglass mesh is embedded in and/or integrally formed with the cured polyurethane foam. The amount and/or type/form of fiberglass combined with the polyurethane foam can vary based on the application and required properties of the structural building members. For example, fiberglass can form approximately zero percent to approximately ninety percent of the sheathing. In some embodiments, the type/form of fiberglass combined with the polyurethane foam can be based on the manufacturing process utilized to form the structural building members, extrusion, pultrusion, and/or cast molding.

FIG. 2B shows a cross section of an example polyurethane foam stud 200B having an elongated body 202 formed with fiberglass roving 230 embedded therein. As shown in FIG. 1B, the fiberglass roving 230 can extend along the longitudinal axis L a portion or entire length 208 of the body 102 from a first end 204 of the body to a second end 208 and/or from the one edge 214 to the other edge 214. The fiberglass roving 230 can be founded by separate continuous strands of fiberglass. In some embodiments, in addition to, or in the alternative of the fiberglass roving 230, individual (continuous) strands 232 of fiberglass can be distributed throughout the body 102.

FIG. 2C shows a cross section of an example polyurethane foam stud 200C having the elongated body 202 formed with fiberglass mesh 240 embedded therein. As shown in FIG. 1C, the fiberglass mesh can extend along the longitudinal axis L a portion or entire length 208 of the body 202 from the first end 204 of the body to the second end 206 and/or from one of the edges 214 to the other edge 214. The fiberglass mesh 240 can be founded by crisscrossing strands of fiberglass and/or by fiberglass roving. In some embodiments, in addition to, or in the alternative of the fiberglass mesh, individual strands of fiberglass can be distributed throughout the body 202.

In some embodiments, the polyurethane foam sheathing can include perforations or the like. The perforations can be formed on the sheathing to reduce the weight of the sheathing and to reduce the amount of material necessary to form sheathing.

### IV. Processes

Exemplary embodiments of the polyurethane foam members (e.g., studs, beams, sheathing) can be formed using an extrusion, a cast molding process, and/or pultrusion.

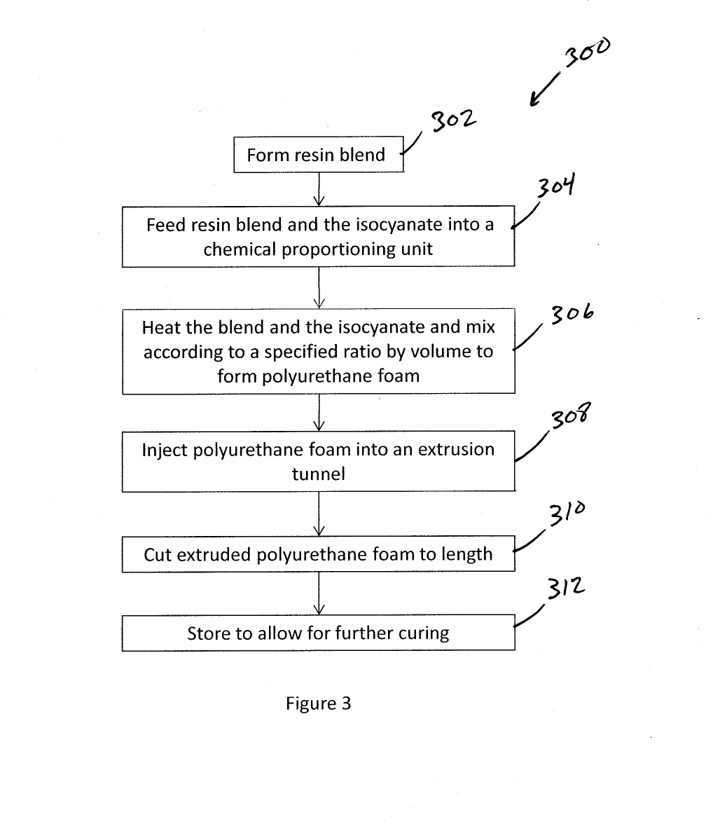

FIG. 3 is a flowchart illustrating an exemplary extrusion process 300 that can be utilized by exemplary embodiments of the present disclosure to form polyurethane foam studs, beams, and/or sheathing. To begin, at step 302, a resin blend is formed from the polyols, amine catalysts, surfactants, fire retardants, blowing agents, and if being used the reinforcement materials. In exemplary embodiments, one or more of fiberglass strands, chopped fiberglass, and/or glass fibers can be added to the resin blend as reinforcement materials. At step 304, the blend and the isocyanate are fed into a chemical proportioning unit, such as those manufactured by Graco, PMC or other manufacturers. At step 306, the chemical proportioning unit heats the blend and the isocyanate and mixing them according to a specified ratio by volume (e.g., a ratio of 1:1 by volume for the exemplary formulation provided in Table 1 or 2 or variations and/or equivalents thereof). The mixture of isocyanate and the blend can form the polyurethane foam, which can be injected by one or more mix heads into an extrusion tunnel at step 308. The extrusion tunnels can be made from a wide variety of materials including fiberglass or metal and can be coated with a non-stick material such as, for example, Teflon or silicone. The extrusion tunnels can be designed to be in the desired shape of the polyurethane foam stud, beam, or sheathing. While passing through the extrusion tunnel, the polyurethane foam cures. The polyurethane foam exits the extrusion tunnel in its cured form and can be cut to a specified or desired length at step 310. The cut polyurethane foam can be stored to allow for further curing at step 312.

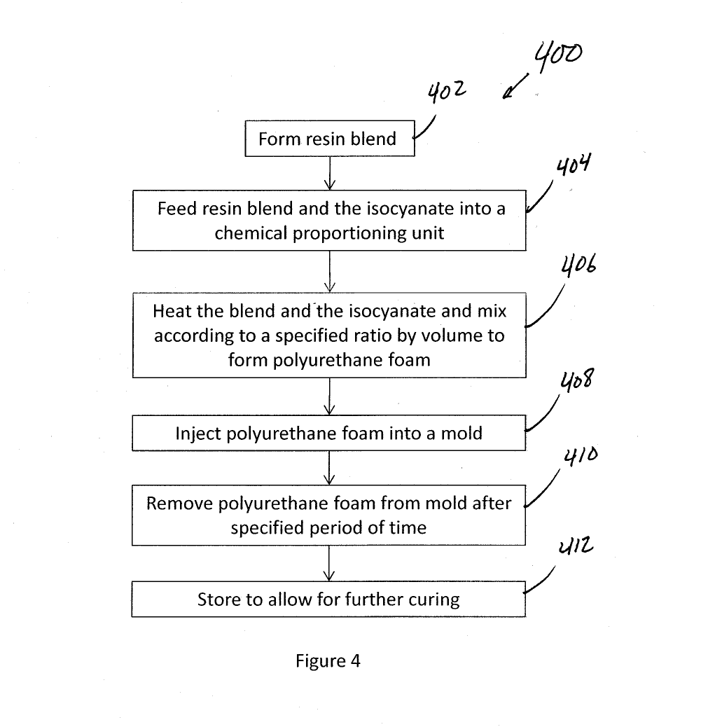

FIG. 4 is a flowchart illustrating an exemplary cast molding process 400 that can be utilized by exemplary embodiments of the present disclosure to form polyurethane foam studs, beams, and/or sheathing. To begin, at step 402, a resin blend is formed from the polyols, amine catalysts, surfactants, fire retardants, blowing agents, and if being used the reinforcement materials. In exemplary embodiments, one or more of fiberglass strands, chopped fiberglass, and/or glass fibers can be added to the resin blend as reinforcement materials. At step 404, the blend and the isocyanate are fed into a chemical proportioning unit, such as those manufactured by Graco, PMC or other manufacturers. At step 406, the chemical proportioning unit heats the blend and the isocyanate and mixing them according to a specified ratio by volume (e.g., a ratio of 1:1 by volume for the exemplary formulation provided in Table 1 or Table 2 or variations and/or equivalents thereof).

The mixture of isocyanate and the blend can form the polyurethane foam, which can be injected by one or more mix heads or proportioning guns into an mold at step 408. The mold can be made from a wide variety of materials including fiberglass or metal and can be coated with a non-stick material such as, for example, Teflon or silicone. In some embodiments, the interior surface of the molds can be lined with a reinforcing material, such as fiberglass strands, fiberglass roving, fiberglass mesh, metal wire, and/or a metal mesh. The resin blend can be deposited in the lined molds such that when the resin blend cures, the polyurethane studs, beams, and/or sheathing can be integrally formed with the reinforcing material. In some embodiments, the resin blend can be deposited in the molds and reinforcing materials, such as fiberglass strands, fiberglass roving, fiberglass mesh, metal wire, and/or a metal mesh, can be inserted in the resin blend such that when the resin blend cures, the polyurethane foam studs, beams, and/or sheathing are integrally formed with the reinforcing material. The mold can be designed to be in the desired shape and dimensions of the polyurethane foam stud or sheathing. The polyurethane foam can be allowed to cure in the mold for a specified time period, after which the mold is open and the polyurethane foam stud or sheathing is removed from the mold at step 410. The molded polyurethane foam can be stored to allow for further curing at step 412. In exemplary embodiments, the molds can be designed with holes through which air can be injected into the mold to help remove the component after curing and/or to provide a vacuum to increase the density and strength of the polyurethane foam stud or sheathing.

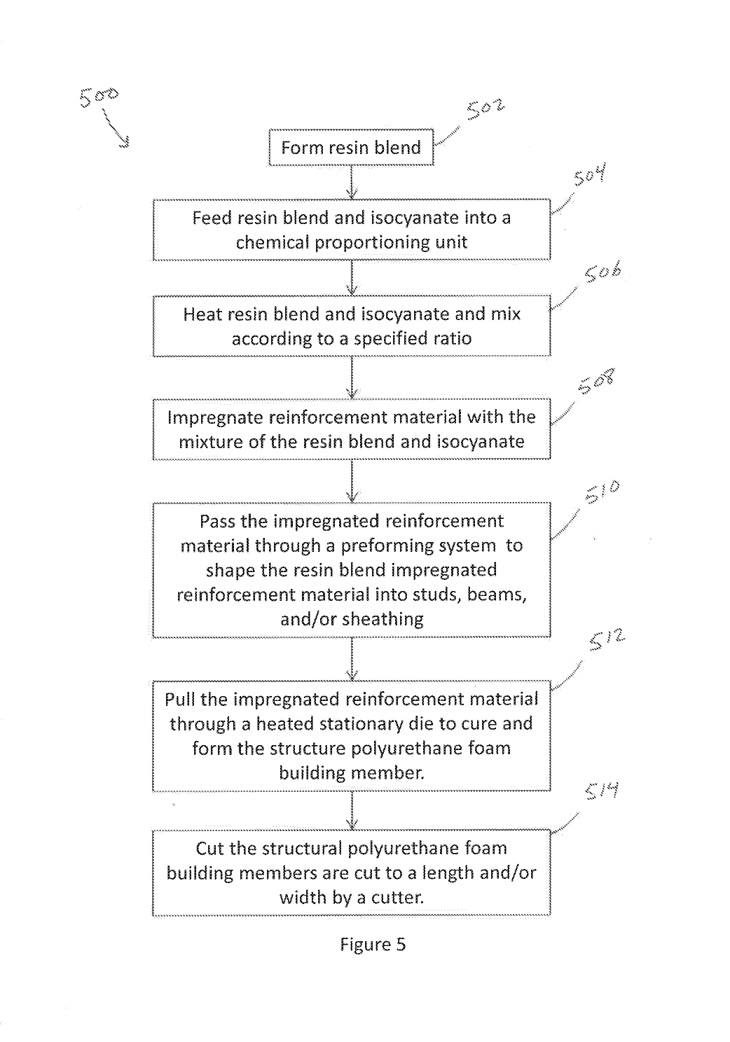

FIG. 5 is a flowchart illustrating an exemplary pultrusion process 500 that can be utilized by exemplary embodiments of the present disclosure to form polyurethane foam studs, beams, and/or sheathing. To begin, at step 502, a resin blend is formed from the polyols, amine catalysts, surfactants, fire retardants, blowing agents, and if being used the reinforcement materials. In exemplary embodiments, one or more of fiberglass strands, chopped fiberglass, and/or glass fibers can be added to the resin blend as reinforcement materials. At step 504, the resin blend and the isocyanate are fed into a chemical proportioning unit, such as those manufactured by Graco, PMC or other manufacturers. At step 506, the chemical proportioning unit heats the blend and the isocyanate and mixes them according to a specified ratio by volume (e.g., a ratio of 1:1 by volume for the exemplary formulation provided in Table 1 or 2 or variations and/or equivalents thereof). The mixture of isocyanate and the blend can form the polyurethane foam. At step 508 reinforcement materials, such as fiberglass strands, fiberglass roving, and/or fiberglass mesh, e.g., in the form of a continuous roll, is guided by tension rollers through a resin impregnator (e.g., a bath of the resin blend mixed with the isocyanate or an injection chamber through the mixture of the resin blend and the isocyanate is injected) in response to being pulled by pulling system/mechanism to impregnate the reinforcement material with the mixture of the resin blend and the isocyanate. At step 510, the impregnated reinforcement material is passed through a preforming system (e.g., to shape the resin blend impregnated reinforcement material into studs, beams, and/or sheathing, and at step 512, the impregnated reinforcement material is pulled (e.g., by the pulling system) through a heated stationary die, where the mixture of the resin blend and isocyanate is cured to form the structural polyurethane foam building member. The heated die station outputs the structural polyurethane foam building members (e.g., studs, beams, and/or sheathing) with the continuous reinforcement material embedded and integrated therein. At step 514, the structural polyurethane foam building members are cut to a length and/or width by a cutter.

### V. Exemplary Building

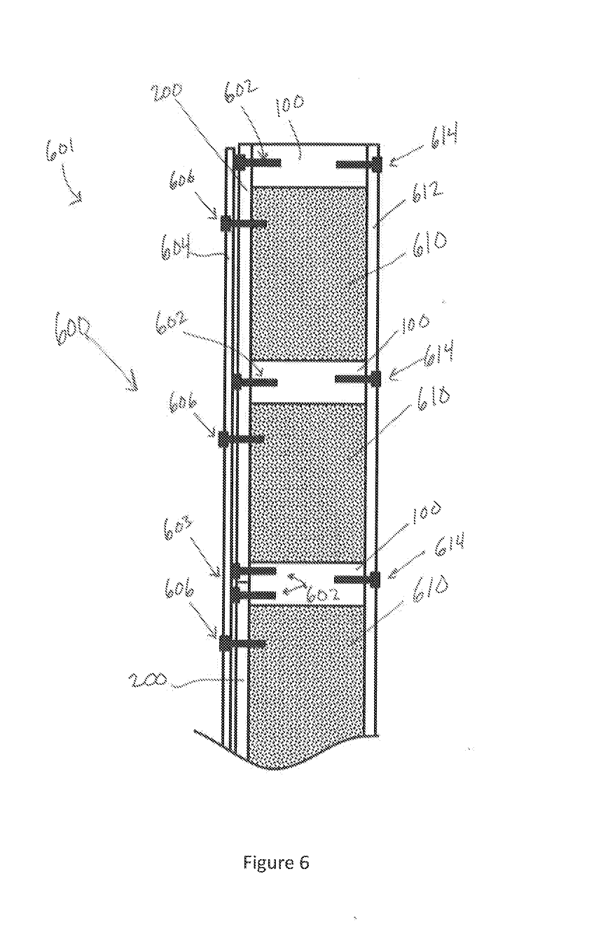

FIG. 6 depicts a cross-sectional view of an exterior wall 600 of a building 601 constructed in accordance with exemplary embodiments of the present disclosure. As shown in FIG. 6, the exterior wall 600 can include the polyurethane foam studs 100 (e.g., studs 100A-C) spaced along a length L_{w} of the wall 600. The studs 100 of the exterior wall 600 can be configured to support a structural load and can have similar or enhanced physical properties as conventional wood studs, but can reduce and/or eliminate thermal bridging typically associated with wood studs.

The polyurethane foam sheathing 200 (e.g., sheathing 200A-C) can be secured to an exterior portion of the studs 100 using conventional fasteners 602, such as nails or screws. The fasteners 602 can be driven into the studs 100 and the studs 100 can securely hold the fasteners 602 such that the fasteners 602 resist being pulled out of the studs 100 to hold the sheathing in place. Joins 603 between sheathing 200 can be generally aligned with a mid-point of the thickness of the stud 100 corresponding to the join location. The sheathing 200 of the exterior wall 600 can be configured to support a structural load and can have similar or enhanced physical properties as conventional plywood or OSB sheathing, but can reduce and/or eliminate thermal bridging typically associated with these convention materials.

Siding 604 can be secured to the sheathing 200 using conventional fasteners 606, such as nails or screws. The fasteners 606 can be driven into the sheathing 200 and the sheathing 200 can securely hold the fasteners 606 such that the fasteners 602 resist being pulled out of the sheathing 200 to hold the siding in place. The siding 604 can be vinyl siding, wood siding, fiber cement siding, and/or any other siding materials suitable for covering an exterior of a building.

In exemplary embodiments, insulation 610 can be disposed between the studs 100. For example, the insulation can be fiberglass insulation, low density polyurethane foam (typically in the range from 0.5 lbs. per cubic foot to 2 lbs. per cubic foot), cellulose, and/or any other insulation suitable for insulating a building can be used. In the present embodiment, the insulation 610 is low density polyurethane foam that has been sprayed between the studs 100 and expands to fill voids between the studs 100.

An interior portion 612 of the wall can be formed by drywall, cement board, and/or any other suitable materials for forming an interior wall of a building. The interior portion 612 can be secured to an interior portion of the studs 100 using conventional fasteners 614 to secure the interior portion 612 to the studs 100. The fasteners 614 can be driven into the studs 100 and the studs 100 can securely hold the fasteners 614 such that the fasteners 614 resist being pulled out of the studs 100 to hold the interior portion 610 in place.

While FIG. 6 is depicting using both the studs 100 and the sheathing 200, those skilled in the art will recognize that building structures can be formed using the studs 100 and/or the sheathing 200 and that the studs 100 or the sheathing 200 can be used with conventional sheathing or studs, respectively. Furthermore, while FIG. 6 depicts an exterior wall, those skilled in the art will recognize that similar structures and arrangements can be formed with polyurethane foam beams in accordance with exemplary embodiments of the present disclosure to form floor and/or roof structures of a building.

By forming an exterior wall using the polyurethane foam studs and/or sheathing, exemplary embodiments of the present disclosure can advantageously provide a structure that has similar physical properties to conventional construction materials, such as wood, while reducing and/or eliminating thermal bridging typically associated with conventional construction materials, such as wood, steel, and/or concrete. Exemplary embodiments of the polyurethane foam studs and/or sheathing can also advantageously provide improved durability and resilience to environment conditions, such as moisture (e.g., can be mold resistant) and/or can be resistant to termite, carpenter ant, carpenter bee, and other insect infestations that can damage wood-based construction materials.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A building construction framing component comprising:
an elongate polyurethane foam body having a length, width, thickness, and density,
wherein the density of the polyurethane foam body is greater than at least approximately five pounds per cubic foot.

2. The building construction framing component of claim 1, wherein the density of the polyurethane foam body is greater than at least approximately twenty-five pounds per cubic foot.

3. The building construction framing component of claim 1, wherein the polyurethane foam body forms at least one of a stud or a beam.

4. The building construction framing component of claim 3, wherein the polyurethane foam body as a width of approximately four inches and a thickness of approximately two inches.

5. The building construction framing component of claim 3, wherein the polyurethane foam body as a width of approximately six inches and a thickness of approximately two inches.

6. The building construction framing component of claim 3, wherein the polyurethane foam body as a width of approximately eight inches and a thickness of approximately two inches.

7. The building construction framing component of claim 3, wherein the polyurethane foam body as a width of approximately ten inches and a thickness of approximately two inches.

8. The building construction framing component of claim 1, wherein the polyurethane foam body forms sheathing.

9. The building construction framing component of claim 8, wherein the polyurethane foam body as a width of approximately four feet and a length of approximately eight feet.

10. The building construction framing component of claim 1, wherein the polyurethane foam body has a thermal insulation R-value per inch of approximately 3 to approximately 8.

11. The building construction framing component of claim 1, wherein the polyurethane foam body is resistant to insect infestations.

12. The building construction framing component of claim 1, wherein the polyurethane foam body is resistant to moisture.

13. The building construction framing component of claim 1, wherein the elongate polyurethane foam body is formed from a polyurethane foam composition of claim 18.

14. A stud comprising:
an elongate polyurethane foam body having a length, width, thickness, and density,
wherein the density of the polyurethane foam body is greater than at least approximately five pounds per cubic foot.

15. The stud of claim 14, wherein the elongate polyurethane foam body is formed from a polyurethane foam composition of claim 18.

16. A sheet of sheathing comprising:
an elongate polyurethane foam body having a length, width, thickness, and density,
wherein the density of the polyurethane foam body is greater than at least approximately five pounds per cubic foot.

17. The sheet of sheathing of claim 16, wherein the elongate polyurethane foam body is formed from a polyurethane foam composition of claim 18.

18. A polyurethane foam composition comprising:
a reaction product of a blend including polyols and an isocyanate,
wherein the blend and the isocyanate are mixed according to a ratio by weight of approximately 1:1.

19. The polyurethane foam composition of claim 18, wherein the polyols further comprises at least one of castor oil, polyester polyol, SG355, propanediol, or Arcol E434.

20. The polyurethane foam composition of claim 19, wherein the polyols include:
approximately three parts by weight of castor oil;
approximately five and a half parts by weight of polyester polyol;
approximately thirty-two parts by weight of SG355;
approximately fifteen parts by weight of propanediol; and
approximately five and a half parts by weight of Arcol E434.

21. The polyurethane foam composition of claim 18, wherein the blend further comprises:
a catalyst;
a surfactant; and
a blowing agent.

22. The polyurethane foam composition of claim 21, wherein the catalyst comprises an amine catalyst.

23. The polyurethane foam composition of claim 21, wherein the surfactant comprises a silicone surfactant.

24. The polyurethane foam of composition of claim 18, wherein the blend further comprises a fire retardant.

25. The polyurethane foam composition of claim 24, wherein the fire retardant comprises at least one of TCPP, RB7980, or PHT4DIOL.

26. The polyurethane foam of composition of claim 18, wherein the blend further comprises a reinforcing material.
